(19) United States
(12) Patent Application Publication
(10) Pub. No.: US 2009/0254546 A1
(43) Pub. Date: Oct. 8, 2009

(54) PERSONALIZED SCREENING OF CONTEXTUALLY RELEVANT CONTENT

(75) Inventor: Suresh Madhavan, Foster City, CA (US)

Correspondence Address: PERKINS COIE LLP, P.O. BOX 1208, SEATTLE, WA, 98111-1208, US

(73) Assignee: PointCross, Inc., Foster City, CA (US)

(21) Appl. No.: 12/418,555

(22) Filed: Apr. 3, 2009

Related U.S. Application Data
(60) Provisional application No. 61/042,233, filed on Apr. 3, 2008.

(51) Int. Cl. G06F 17/30

(52) U.S. Cl. 707/5; 707/103 R; 707/E17.099; 707/E17.108

(57) ABSTRACT

A system and method store and locate objects within a business organization. Objects created by individuals are stored in association with a context for which they are created. Security can be used to prevent unauthorized individuals from accessing objects without permission.

### RELATED APPLICATIONS

This Application claims priority to U.S. Provisional Patent Application No. 61/042,233, filed Apr. 3, 2008, and entitled “Personalized Screening of Contextually Relevant Content” by Suresh Madhavan, which is incorporated herein by reference.

### BACKGROUND

A business organization includes individuals that work together on projects. Each project has a business purpose that furthers objectives of the organization. The business organization can be defined by these projects.

Each project can be defined by its business reason for existing. This business reason can be referred to as a context for the project. Within the context, individuals work to further the business purpose of the project. This work furthers the objectives of the organization.

While working on the projects the individuals create documents, presentations, emails, and other various “objects.” Individuals often share objects among themselves to benefit from collective knowledge and experience. For example, many individuals can work together to create a single object by distributing the work among the individuals. Alternatively, a single individual can create an object and distribute it to other individuals.

However, collaboration can be impeded by complexity of the business organization. In many organizations multiple different titles can often refer to the same individual. For example, a company president may be formally referred to as a “CEO,” and then informally referred to as “head-honcho,” or “boss.” The titles can be used to identify the individual by reference to the project on which the individual is working. Such naming issues can impede effective collaboration because objects may be buried in storage, lacking organization. Individuals waste time searching for pertinent objects or re-creating them.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique for management of objects uses an ontology defined from a business organization. The ontology is defined in terms of business contexts. Each project of the business organization has a context reflected in the ontology. The ontology can associate objects and individuals with a context to describe a project of the business organization, subject to security. The resulting ontology can identify requested objects for an individual submitting search criteria automatically, or manually. The search criteria can be used to generate keywords for searching the ontology using a search provider. Where a user has permission to see the search results, pertinent objects can be delivered to the user.

A system implementing the technique includes a context agent operable to store an object in association with a context. The system can include a search provider and indexes. When needed the agent retrieves the object from the ontology. Retrieval may involve searching for the object.

In a non-limiting example, a CEO (chief executive officer) creates a presentation for a governing counsel and provides the presentation to a business ontology for storage. A context agent receives the presentation and associates the presentation with a context for the governing counsel using the title of the CEO and his role in presenting to the governing counsel. The CEO or another authorized individual retrieves the presentation when needed.

### BRIEF DESCRIPTION OF THE DRAWINGS

FIG. 1 depicts an example of a system for personalized screening of content.

FIG. 2 depicts an example of a business ontology system for searching for content stored in a business ontology.

FIG. 3 depicts an example of a flowchart for screening pertinent content.

FIGS. 4A-B depict an example of a business ontology agent contextualizing a new object.

FIG. 5 depicts an example of a flowchart for storing new content updating an index to reflect the new content.

FIG. 6 depicts an example of a diagram of a business ontology.

FIG. 7 depicts an example of a computing device suitable for personalized screening of content.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

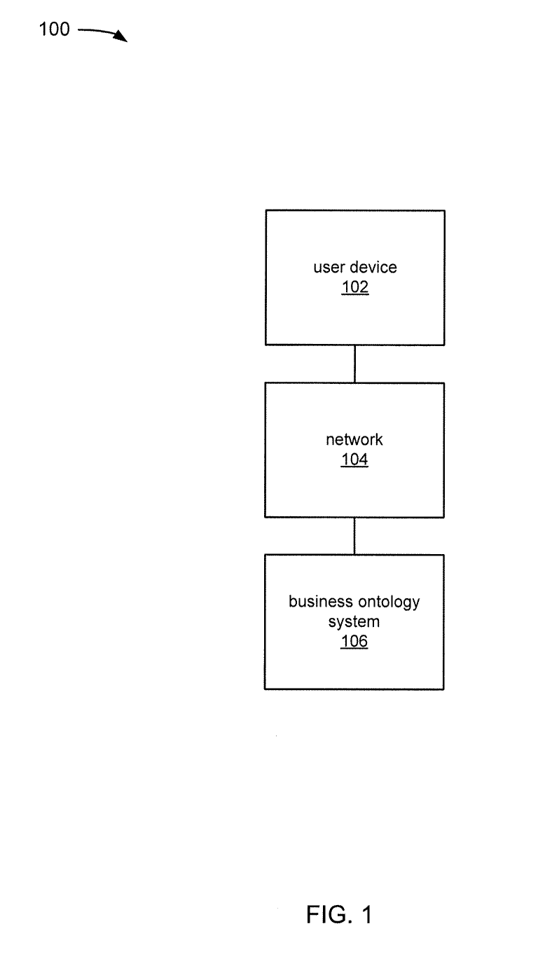

FIG. 1 depicts an example of a system 100 for personalized screening of content. FIG. 1 includes user device 102, network 104, and business ontology system 106.

User device 102 can be any known or convenient computing device operable to generate search queries for objects in a database and/or store and retrieve objects. The user device 102 is typically associated with an individual who performs roles within various contexts. A “role” is a purpose fulfilled by the individual within a context. A role may be identified by different names, but the function performed is common. More than one individual may perform a single role. The user device 102 has permission to store and retrieve objects on behalf of the user.

As used in this paper, a network, such as network 104, can include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 104 broadly includes, as understood from relevant context, anything from a minimalist coupling of the components illustrated in the example of FIG. 1, to every component of the Internet and networks coupled to the Internet.

Business ontology system 106 is a logical representation of a business organization. The business ontology system 106 can describe the business organization using a taxonomy tree, roles tree, and contexts tree. The taxonomy tree, roles tree, and contexts tree may be implemented using any known or convenient manner of storing and retrieving data. In a non-limiting example, the business ontology is implemented in tables of one or more relational databases including schema to capture the relationships of taxonomy to roles, roles to contexts, and contexts to objects, as well as any other necessary relationships.

A “taxonomy” includes a relationship between one or more names, titles, terms or other identifiers of a role performed by an individual. The taxonomy tree relates the name or title of the individual to other names or titles for the same function performed by the individual. A taxonomy can be local or global. Typically, a local taxonomy is defined for a small geographic area, where similar terms are used for roles. A global taxonomy is defined with broader, possibly world-wide scope, for which different terms in various languages can be used for the same role.

As discussed above, a “context” is, in essence, a business purpose for a project. Functionally, within a business ontology system 106, a “context” is an organizational unit that associates roles with individuals performing the roles in a real-world project. The context tree identifies roles and objects that are created and used in furtherance of the business purpose of the project. These individuals, the objects that they create, and the roles that they perform constitute the real-world project. In this way a context tree captures a real world project within the business ontology system 106.

A context can be personal to an individual within the business organization. The personal context associates objects that relate directly to the individual. Access can be restricted to the individual, subject to supervisory authority.

In a non-limiting example, a context tree can be defined as a database entry to include fields for a unique identifier associated with a user, one or more pointers to meta-data for files, one or more pointers to files, one or more links to a parent context, one or more links to sibling contexts, one or more links to child contexts, and one or more links to one or more taxonomy entries. Any known or convenient elements may additionally be used as well.

A context tree is supplemented by context agent(s). A “context agent” is a program executing on one or more hardware units to further the business purpose of a specific context. A context agent can perform actions on behalf of the context such as storing objects, and associating individuals with roles. The context agent typically has access to objects identified by the context tree.

Within a business ontology there can be many contexts and therefore, many agents. The agents can operate together to manage the representation of the business organization within the business ontology system. Such a group of agents can be referred to as a “federated society of agents.”

Security can be used to prevent individuals from accessing objects without permission. Various levels of security can be specified. For example, consider “eyes only” and “need to now” bases of security. Regarding “need to know,” some individuals may require access to objects because they have a “need to know” of the objects, even if they do not know where the objects came from or why they were created. “Eyes only” can specify that only the individual creating the object, or specifically authorized members, may see the object.

In a non-limiting example of “need to know” security, a compliance office of a business organization can have access to objects stored by the business ontology system 106 to ensure that the business organization conforms to the relevant laws. Such an individual may not be informed of why or by whom an object was created, but yet security can be granted to this individual because he has a “need to know” of the object.

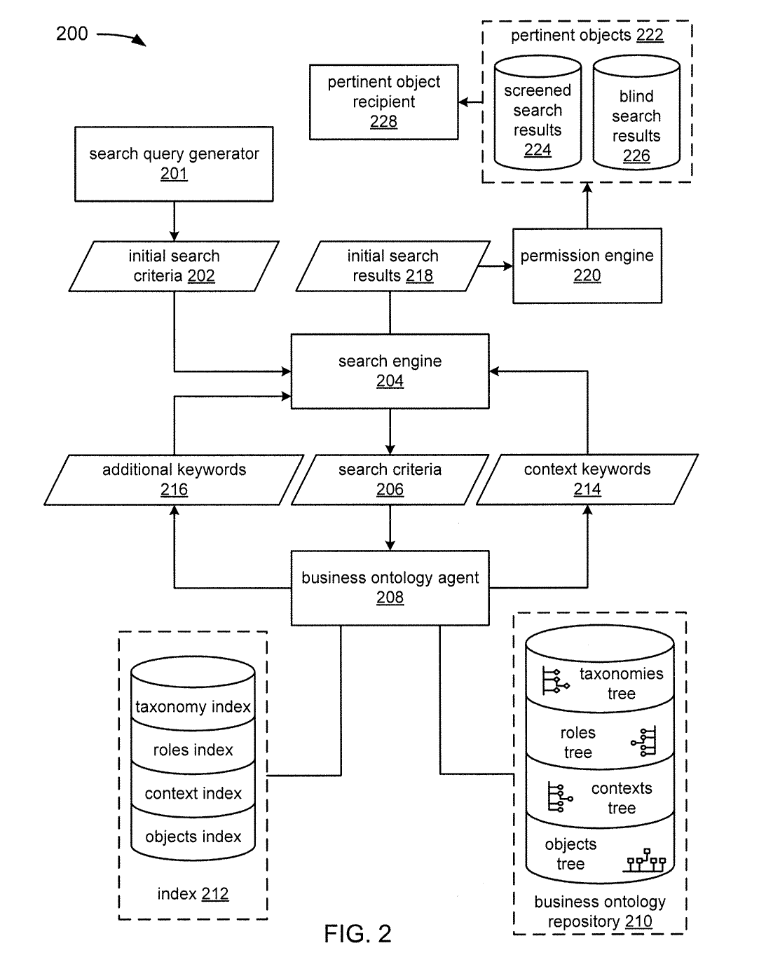

FIG. 2 depicts an example of a business ontology system 200 for personalizing content stored in a business ontology. FIG. 2 includes search query generator 201, initial search criteria 202, search engine 204, search criteria 206, business ontology agent 208, business ontology repository 210, index 212, context keywords 214, additional keywords 216, initial search results 218, permission engine 220, pertinent objects 222, and pertinent object recipient 228. The pertinent objects 222 include screened search results 224 and blind search results 226.

In the example of FIG. 2, the search query generator 201 can be implemented on a user device, an end user computing system, proxy device or other applicable known or convenient unit. The initial search criteria can include keywords, phrases, terms and other known or convenient items.

In the example of FIG. 2, the search engine 204 can be a proprietary or commercial search engine. In a non-limiting example, the search engine 204 is a commercial search engine provided by Microsoft Corporation of Redmond Wash., or Google Inc. of Mountain View, Calif.

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. As used herein an engine can include software implemented on hardware.

In the example of FIG. 2, the search criteria 206 include keywords that affect a feedback loop on the business ontology agent 208. Search criteria 206 can include some or all of the initial search criteria 202, the additional keywords 216, and the context keywords 214.

In the example of FIG. 2, business ontology agent 208 is an engine that can perform actions on behalf of the business ontology repository 210 including indexing, storing, retrieving, and otherwise managing information stored within the business ontology repository 210.

In the example of FIG. 2, the business ontology repository 210 includes a taxonomy tree, roles tree, contexts tree, and objects tree. The business ontology repository 210 can store these trees in any known or convenient data storage system. As used in this paper, a repository can be implemented, for example, as software embodied in a physical computer-readable medium on a general- or specific-purpose machine, in firmware, in hardware, in a combination thereof, or in any applicable known or convenient device or system. The repositories described in this paper are intended, if applicable, to include any organization of data, including trees, tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Netezza, Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 2, the index 212 is a repository that facilitates relatively rapid searches for contexts in the business ontology repository 210. The context index can identify projects conducted by the business organization described by the business ontology repository 210. The context index can be regularly or continuously updated. The taxonomy index can store data that improves the speed of searches performed on the taxonomy tree of the business ontology repository 210. When supplied with titles, names, roles or other identifiers, the taxonomy index can produce related titles, names or roles. The taxonomy index can be regularly or continuously updated. The objects index can improve the speed of searches for objects in the business ontology repository 210. The objects index can include the names of objects stored by the business ontology repository 210. The objects index can be regularly or continuously updated.

In the example of FIG. 2, the context keywords 214 include terms and phrases derived from context(s) of the business ontology repository 210. The context(s) used can be selected by identifying the contexts associated with a user. Such contexts can be likely to have keywords related to the pertinent content because the contexts capture information about the user's projects. The context keywords 214 may include names of persons associated with the context, roles associated with the context, context specific keywords, or other context specific information.

In the example of FIG. 2, the additional keywords 216 can include names, roles, titles and other known or convenient information generated from the index 212 using the context keywords 214.

In the example of FIG. 2, the initial search results 218 include objects identified by the search engine 204 using the additional keywords 216 and context keywords 214.

In the example of FIG. 2, the permission engine 220 can screen objects from individuals lacking permission to view the objects. Some individuals may have a need to know of the object, but lack permission to view the object. For such objects the permission engine 220 can provide the objects without reference to the source of the objects.

In the example of FIG. 2, the pertinent objects 222 can include screened search results 224 and blind search results 226. The screened search results 224 can include objects returned by the search engine 204 that the user has permission to view. Blind search results 226 can include objects that the user has a need to know of, but lacks permission to view.

In the example of FIG. 2, the pertinent object recipient 228 can be implemented on a user device, an end user computing system, proxy device, storage location, or other known or convenient unit. The pertinent object recipient 228 may or may not be implemented on the same device as the search query generator 201.

In the example of FIG. 2, in operation, the search engine 204 receives initial search criteria 202 and provides the initial search criteria 202 to business ontology agent 208 included in the search criteria 206. Business ontology agent 208 uses the search criteria to produce context keywords 214 using the business ontology repository 210. The business ontology agent 208 can then use the search criteria 206 with the index 212 to produce the additional keywords 216.

The search engine 204 then uses each of the initial search criteria 204, the additional keywords 216, and the context keywords 214 to produce the initial search results 218.

The permission analyzer 220 filters the initial search results 218. Where the entity has permission to view objects found in the initial search results 218, the objects are included in the screened search results 224. Where the entity lacks permission to view the objects, the permission analyzer excludes the objects from pertinent objects 222 unless the user has a need to know of the objects. Need to know objects are included in the blind search results 226. The pertinent objects 222 thus includes the screened search results 224 and the blind search results 226. Pertinent objects 222 are then provided to the pertinent object recipient.

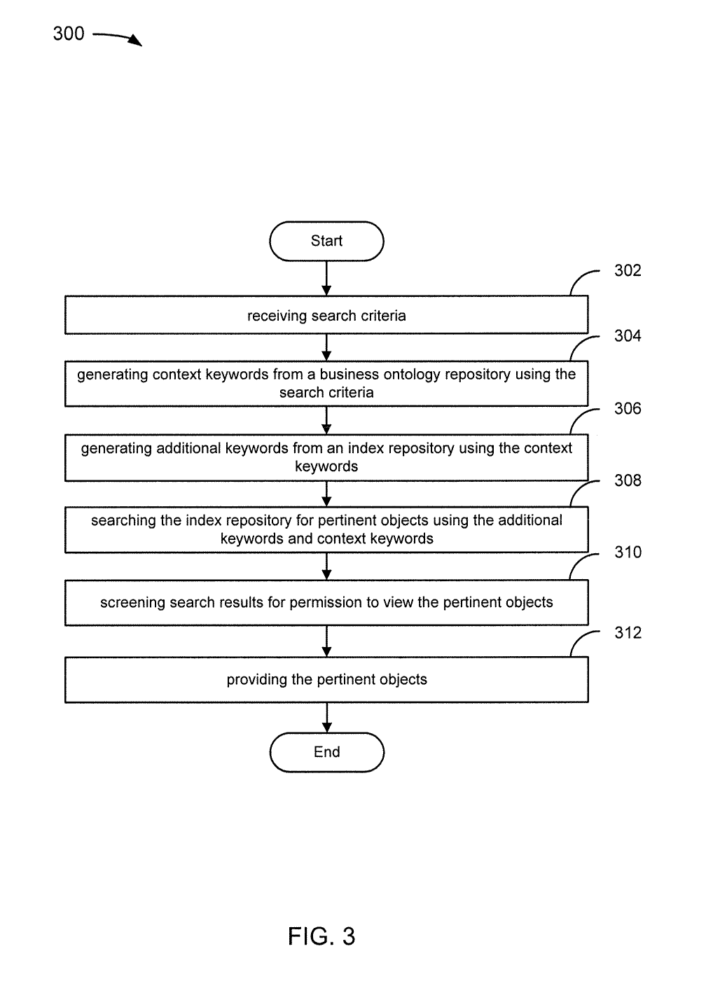

FIG. 3 depicts an example of a flowchart 300 for screening pertinent content. The flowchart 300 is organized as a sequence of modules. However, it should be understood that these and modules associated with other methods described herein may be reordered for parallel execution or into different sequences of modules.

In the example of FIG. 3, the flowchart starts at module 302 with receiving search criteria. A user can provide the search criteria, or alternatively, a software entity may provide the search criteria automatically. For automatic searches, the entity can be a business ontology agent acting on behalf of the context to provide the user with pertinent objects. The search criteria can include keywords, phrases, terms and other applicable known or convenient information.

In the example of FIG. 3, the flowchart continues to module 304 with generating context keywords from a business ontology repository using the search criteria. A context index can be used to identify context keywords by identifying the contexts that the user is associated with and comparing the search criteria with keywords found in the context index.

In the example of FIG. 3, the flowchart continues to module 306 with generating additional keywords from an index repository using the context keywords. The taxonomy index can compare and relate the context keywords to the taxonomy index to produce the additional keywords. The additional keywords may include the original context keywords as well as keywords found in the taxonomy index.

In the example of FIG. 3, the flowchart continues to module 308 with searching the index repository for pertinent objects using the additional keywords and context keywords. A commercial search engine can perform the searching, such as one available from Microsoft Corporation of Redmond Wash., or Google, Inc. of Mountain View, Calif.

In the example of FIG. 3, the flowchart continues to module 310 with screening search results for permission to view the pertinent objects. Where an entity has permission to view objects included in the initial search results the objects are provided to the entity as screened search results. Where the entity does not have permission to view the objects, but has a need to know of the objects, the objects are provided to the entity as blind search results.

In the example of FIG. 3, the flowchart continue to module 312 with providing the pertinent objects. Together, blind search results and screened search results are provided to the entity as pertinent content. Having provided pertinent content to the entity, the flowchart terminates.

Advantageously, the initial search criteria can be used to generate keywords from a business ontology repository. Although search criteria are known, using a knowledge repository can be used to generate keywords that perhaps a user who provided the search criteria would not have thought of, or would not be immediately apparent to a user with a given amount of knowledge about the repository. Moreover, additional keywords beyond the scope of the initial search criteria can be generated using institutional knowledge captured in the business ontology repository. The institutional knowledge can exceed the scope of the individual user's knowledge yielding a more thorough search than would be possible using only the user's knowledge. As used in this paper, the scope of a search is intended to mean the possible results one could obtain by using a set of keywords provided in association with the search. As used in this paper, “beyond the scope” of a search is intended to mean the results one could obtain by using the initial search criteria and keywords derived from the initial search criteria using a business ontology repository. Context keywords and additional words can yield search results beyond the scope of the initial keywords while maintaining pertinence to the user. As used herein, “pertinence to a user” is a positive relationship between objects found and the context within which the user is performing her search based on the role played by the user within the context. A pertinent search can be performed using initial search criteria and the identity of a user associated with the search to find context keywords and additional keywords that are associated with both the initial search criteria and the user. Using a business ontology repository enables one to expand the scope of the initial search criteria while remaining within a relevant context for a matter or the institution as a whole.

For example, consider a design engineer working for a semiconductor fabrication company. The user is developing a new transistor for implementation in a new process. The user searches for “budgeting information” as his initial search criteria. The business ontology agent receives the initial search criteria and information describing the engineer's position. The business ontology agent identifies a context for the project associated with the new transistor and generates context keywords including the name of the project “sub-micro” and “A1230” a project identifier for the new transistor. The context keywords are used to feedback a search through the index which generates additional keywords “Taiwan,” the location of the project engineer and “old-transistor,” the name of a predecessor project. The search engine uses the keywords, “budgeting information,” “sub-micro,” “A1230,” “Taiwan,” and “old-transistor” to an index of an objects tree to find pertinent objects. The “A1230” keyword is used to find an excel spreadsheet of budget information released by management for all employees, and the “sub-micro” keyword is used to find cost specifications for fabrication technologies used by the company generally, both pertinent to the engineer's project. The “sub-micro” keyword is also used to find management notes and a performance evaluation of the design engineer; this result is screened out because the design engineer does not have permission to view his performance evaluation. The “old-transistor” keyword can be used to find a report by a second engineer having the same role within the old transistor project as the design engineer in the sub-micro project. The results of this search are pertinent to the design engineer and would likely be different for someone having a different identity, role played within a context or other scope limiting characteristic.

The context keywords are derived from the initial search criteria and the additional keywords are derived from the context keywords because the context keywords are used to determine the additional keywords. Accordingly, the context keywords can be referred to as first level derivative keywords and the additional keywords can be referred to as second level derivative keywords.

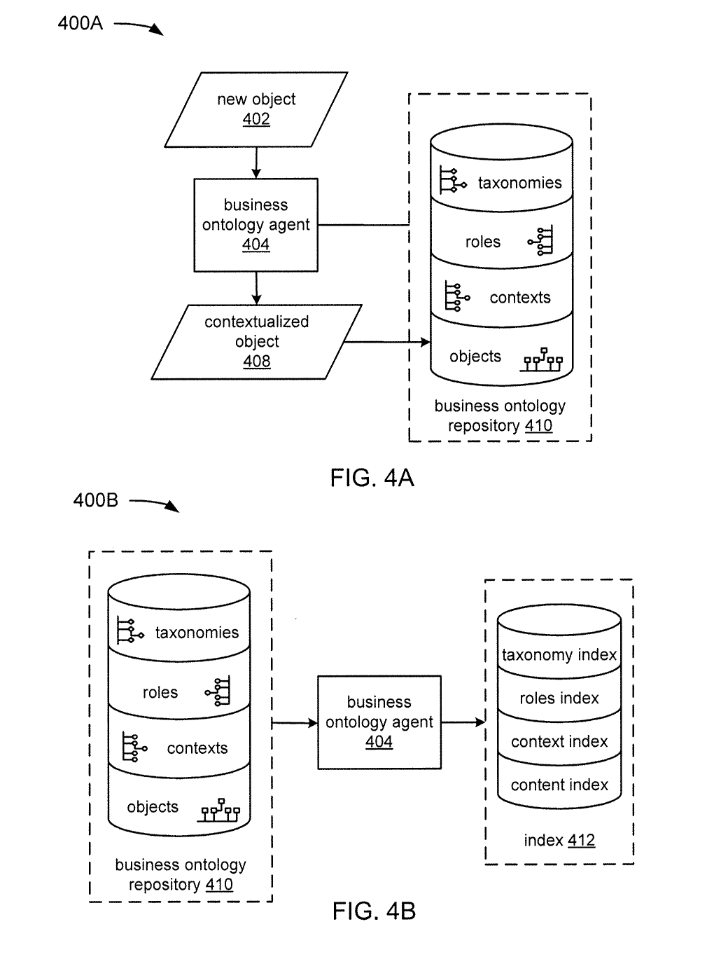

FIGS. 4A-B depict an example of a business ontology agent contextualizing a new object. FIG. 4A-B includes new object 402, business ontology agent 404, contextualized object 408, business ontology repository 410, and index 412.

In the example of FIG. 4A, the new object 402 can include a document, container or other applicable known or convenient object. The new object 402 may be associated with an individual including information regarding the individual's role within a context for creating the object. Such an association can be made by using information about the individual such as e-mail address, unique identifier, internet protocol (IP) address, or a known or convenient identifier. Additionally, the individual can specify a context for the new object 402.

In the example of FIG. 4, the business ontology agent 404 can be a business ontology agent as discussed above in reference to FIG. 2.

In the example of FIG. 4, the contextualized object 408 is an object that has been associated with a context in the business ontology repository 410. As discussed above, the contextualized object is defined as the new object 402 with an association to a context.

In the example of FIG. 4, the business ontology repository 410 can be a business ontology repository as discussed above in reference to FIG. 2.

In the example of FIG. 4, in operation, new object 402 is received by the business ontology agent 404. If an entity specifies a context for the new object 402, the business ontology agent 404 stores the new object 402 in association with the context specified. For example, the entity can include a person who created the new object, an entity that provided the new object 402 to the business ontology agent 404, or some other entity.

If the entity does not provide a context for the new content the business ontology agent 404 finds a context relevant to the entity. For example, the business ontology agent 404 can search the taxonomies of the business ontology repository 410 for roles played by the entity, find a context associated with the re: line of an email, or find a context associated with some other characteristic associated with the entity or the new object. Having identified roles for the entity, the context agent identifies contexts associated with the roles and selects a context to associate with the new object 402.

The new object 402 is associated with the context to become the contextualized object 408. For example, the business ontology agent 404 receives an email from a California sales representative and associates the email with a North American sales context, the business ontology agent 404 receives a document with an identifier that enables the business ontology agent to associate the document with an appropriate context, or the business ontology agent receives a new object and associates the new object with a context in some other manner. Once the new object has been associated with the appropriate context the object can be referred to as “contextualized.” The contextualized object 408 is then stored in the business ontology repository 410.

In the example of FIG. 4B, in operation, the business ontology agent 404 updates the index 412. For example, the business ontology agent 404 can hash a name or identifier for the object and stores the hash in the index 412, the business ontology agent 404 can create a reference to the object and store the reference in the index 412, or the business ontology agent 404 can index the contextualized object 408 in the index 412 in a known or convenient manner. This update can be performed at any time, but is typically performed after contextualizing a new object, such as is discussed in reference to FIG. 4A.

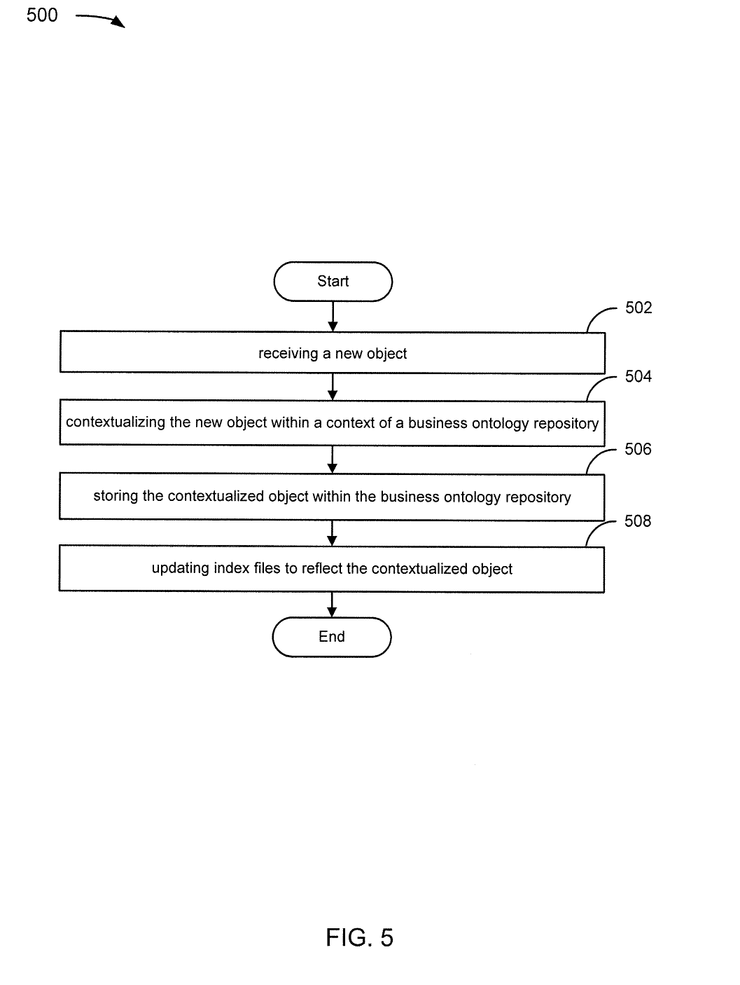

FIG. 5 depicts an example of a flowchart 500 for storing new content updating an index to reflect the new content. The flowchart 500 is organized as a sequence of modules. However, it should be understood that these and modules associated with other methods described herein may be reordered for parallel execution or into different sequences of modules.

In the example of FIG. 5, the flowchart starts at module 502 with receiving a new object. An individual can provide the new object, or the object may be automatically generated by a process.

In the example of FIG. 5, the flowchart continues to module 504 with contextualizing the new object within a context of a business ontology repository. If a context is specified, a business ontology agent can associate the new object with the specified context by, for example, associating the object with context keywords. If a context is not specified the business ontology agent can identify a context for the object as was described in reference to FIGS. 4A-B.

In the example of FIG. 5, the flowchart continues to module 506 with storing the contextualized object within the business ontology repository. Storage can include adding references to trees within the business ontology, copying the object to a mass storage device, and otherwise integrating the object into the business ontology. As used herein, integration can include referencing and cross-referencing the object with keywords for relatively rapid search. The contextualized content can be stored in a business ontology along with objects stored in the business ontology.

In the example of FIG. 5, the flowchart continues to module 508 with updating index files to include the contextualized object. A business ontology agent can update index files to reflect the new object. Having updated index files to facilitate relatively rapid search for the contextualized object, the flowchart terminates.

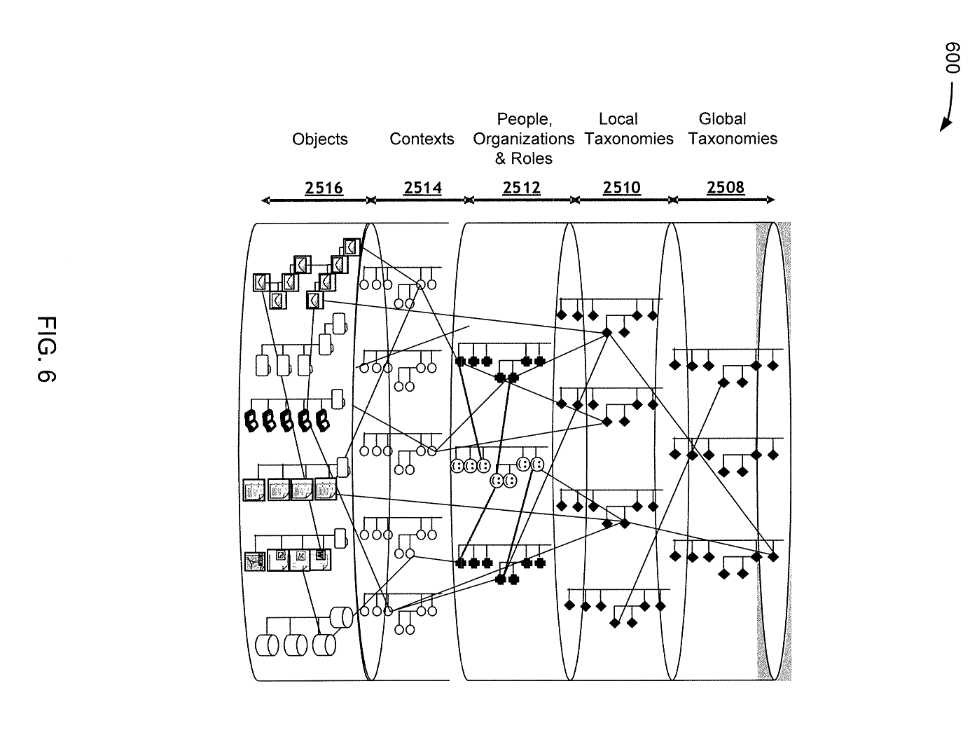

FIG. 6 depicts an example of a diagram 600 of a business ontology. FIG. 6 is intended to conceptually illustrate links between various entries in a business ontology repository. The graphical representations of various fractions of a business ontology could be modified as is known or convenient.

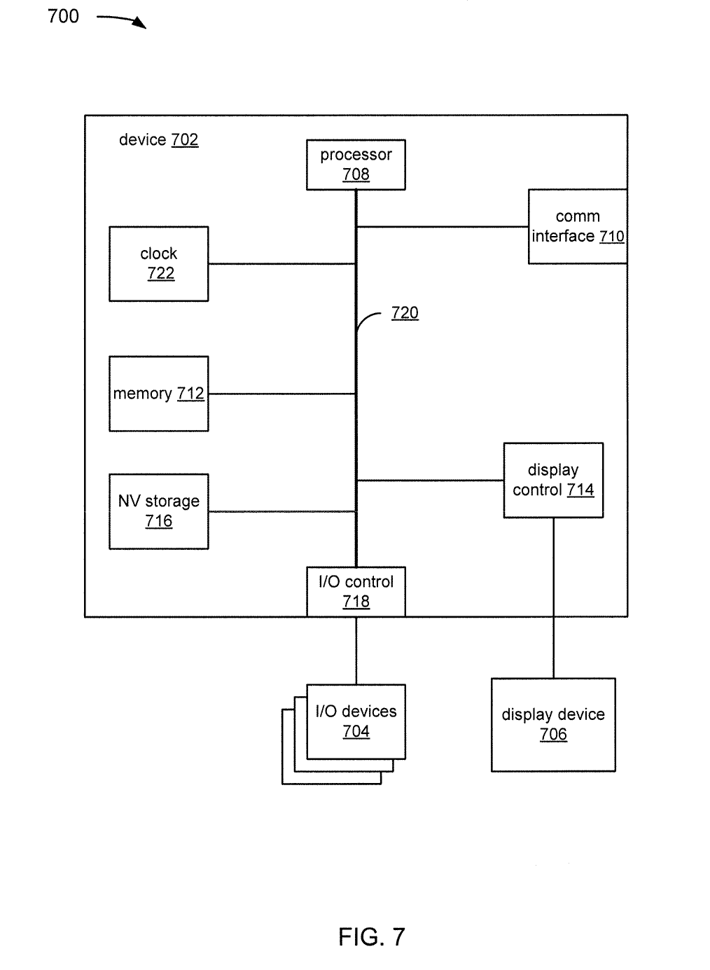

FIG. 7 depicts an example of a system 700 suitable for personalized screening of content. The system 700 may be a conventional computer system that can be used as a client computer system, such as a wireless client or a workstation, or a server computer system. The system 700 includes a device 702, I/O devices 704, and a display device 706. The device 702 includes a processor 708, a communications interface 710, memory 712, display controller 714, non-volatile storage 716, I/O controller 718, clock 722. The device 702 may be coupled to or include the I/O devices 704 and the display device 706.

The device 702 interfaces to external systems through the communications interface 710, which may include a modem or network interface. It will be appreciated that the communications interface 710 can be considered to be part of the system 700 or a part of the device 702. The communications interface 710 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 708 may be, for example, a conventional microprocessor such as an Intel Pentium microprocessor or Motorola power PC microprocessor. The memory 712 is coupled to the processor 708 by a bus 720. The memory 712 can be Dynamic Random Access Memory (DRAM) and can also include Static RAM (SRAM). The bus 720 couples the processor 708 to the memory 712, also to the non-volatile storage 716, to the display controller 714, and to the I/O controller 718.

The I/O devices 704 can include a keyboard, disk drives, printers, a scanner, and other input and output devices, including a mouse or other pointing device. The display controller 714 may control in the conventional manner a display on the display device 706, which can be, for example, a cathode ray tube (CRT) or liquid crystal display (LCD). The display controller 714 and the I/O controller 718 can be implemented with conventional well known technology.

The non-volatile storage 716 is often a magnetic hard disk, flash memory, an optical disk, or another form of storage for large amounts of data. Some of this data is often written, by a direct memory access process, into memory 712 during execution of software in the device 702. One of skill in the art will immediately recognize that the terms “machine-readable medium” or “computer-readable medium” includes any type of storage device that is accessible by the processor 708.

Clock 722 can be any kind of oscillating circuit creating an electrical signal with a precise frequency. In a non-limiting example, clock 722 could be a crystal oscillator using the mechanical resonance of vibrating crystal to generate the electrical signal.

The system 700 is one example of many possible computer systems which have different architectures. For example, personal computers based on an Intel microprocessor often have multiple buses, one of which can be an I/O bus for the peripherals and one that directly connects the processor 708 and the memory 712 (often referred to as a memory bus). The buses are connected together through bridge components that perform any necessary translation due to differing bus protocols.

Network computers are another type of computer system that can be used in conjunction with the teachings provided herein. Network computers need not include a hard disk or other mass storage, and the executable programs are loaded from a network connection into the memory 712 for execution by the processor 708. A Web TV system, which is known in the art, is also considered to be a computer system, but it may lack some of the features shown in FIG. 7, such as certain input or output devices. A typical computer system will usually include at least a processor, memory, and a bus coupling the memory to the processor.

In addition, the system 700 is controlled by operating system software. One example of operating system software is the family of operating systems known as Windows® from Microsoft Corporation of Redmond, Wash. Another example of operating system software is the Linux operating system.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a business ontology repository including a taxonomies tree, a contexts tree, and an objects tree;
an index repository, including a taxonomy index and an objects index;
a business ontology agent coupled to the business ontology repository and the index repository;
wherein, in operation,
the business ontology agent receives search criteria from a search engine, identifies a context using the business ontology repository and the index repository for the search criteria, generates context keywords relating the search criteria to the context, generates additional keywords from the taxonomy index, and provides keywords including the context keywords and additional keywords to the search engine;
the search engine searches the objects index for the keywords to generate initial search results including the objects stored in the business ontology repository and stores the initial search results to facilitate generation of pertinent objects associated with the search criteria.

2. The system of claim 1, further comprising a permission analyzer, wherein in operation the permission analyzer screens the search results for objects that an entity associated with the user device has permission to see and excludes objects that the entity does not have permission to see.

3. The system of claim 1, further comprising a permission analyzer, wherein in operation, the permission analyzer provides blind search results to an entity having an need to know level of security to view the blind search results.

4. The system of claim 1, wherein a roles index is used by the business ontology agent to derive a subset of the additional keywords for searching the objects index.

5. The system of claim 1, wherein the context is associated with an individual as a personal context, and the search results include objects pertinent to the individual.

6. A method comprising:
receiving search criteria,
generating context keywords from a business ontology repository using the search criteria;
generating additional keywords from an index repository using the context keywords;
providing the context keywords and additional keywords to a search engine;
screening search results from the search engine for permission to view pertinent objects found by the search engine;
making the pertinent objects available.

7. The method of claim 6, wherein a business ontology agent facilitates the generation of context keywords and additional keywords.

8. The method of claim 6 wherein the index repository is generated by the business ontology agent using the business ontology repository.

9. A system comprising:
a business ontology repository including a contexts tree and an objects tree;
a business ontology agent coupled to the business ontology repository;
wherein, in operation, the business ontology agent receives a new object, identifies context keywords in the contexts tree for the new object, contextualizes the new object by associating the new object with the context keywords, and stores a reference to the contextualized object within the objects tree;
wherein the context keywords are provided in response to search criteria submitted to the business ontology agent and used to find the contextualized object.

10. The system of claim 9 further comprising, searching the taxonomies tree for roles associated with an individual that created the new object.

11. The system of claim 9 wherein the object is stored with access to the object restricted to entities having permission to view the object.

12. The system of claim 9 wherein the business ontology agent updates an index from the business ontology to reflect the contextualized object.

13. The system of claim 9 wherein permission to view the object is granted to one or more entities having a need to know level of permission associated with the object.

14. A method comprising:
receiving a new object;
contextualizing the new object within a context of a business ontology repository;
storing the contextualized object within the business ontology repository, wherein the contextualized object is integrated into the business ontology;
updating index files to reflect the contextualized object.

15. The method of claim 14 further comprising identifying the contextualized object as associated with an entity playing a role in the context.

16. The method of claim 14 further comprising identifying a role for the entity by searching a taxonomy tree.

17. The system of claim 14 wherein access to the object is restricted to entities having permission to view the object.

18. The method of claim 14 wherein a business ontology agent stores the object within the business ontology repository.

19. The method of claim 14 wherein a business ontology agent updates an index to reflect the contextualized object.

20. The method of claim 14 further comprising searching for the new object within the index file.
